(19) United States
(12) Patent Application Publication
(10) Pub. No.: US 2015/0303990 A1
(43) Pub. Date: Oct. 22, 2015

(54) WIRELESS INTERFERENCE SCANNING METHOD AND DEVICE FOR ADAPTIVE FREQUENCY HOPPING

(71) Applicant: ISSC Technologies Corp., Hsinchu City (TW)

(72) Inventor: PENG-SEN CHEN, HSINCHU COUNTY (TW)

(21) Appl. No.: 14/321,944

(22) Filed: Jul. 2, 2014

(30) Foreign Application Priority Data
Apr. 16, 2014 (TW) 103113883

(51) Int. Cl. H04B 1/7143; H04B 17/00

(52) U.S. Cl. CPC H04B 1/7143; H04B 17/005; H04B 2201/71323; H04B 2201/71315

(57) ABSTRACT

The present disclosure provides a wireless interference scanning method and device for adaptive frequency hopping. The wireless interference scanning method comprise detecting the overall signal magnitude over a wide-band; determining whether the overall signal magnitude over the wide-band is larger than a threshold; sequentially detecting a plurality of channels in the wide-band to determine whether there is an interference signal in the channels when the overall signal magnitude over the wide-band is larger than the threshold; and redetecting the overall signal magnitude over the wide-band for determining whether the overall signal magnitude over the wide-band is larger than the threshold when the overall signal magnitude over the wide-band is not larger than the threshold.

### BACKGROUND OF THE INVENTION

1. Field of the Invention

The instant disclosure relates to a frequency hopping technology; in particular, to a wireless interference scanning method and a device for adaptive frequency hopping.

2. Description of Related Art

Please refer to FIG. 1 showing a schematic diagram of a conventional wireless receiver. The antenna 101 of the wireless receiver receives the wireless signal and transmits the wireless signal to the low-noise amplifier 102. The mixer 103 mixes the local oscillating signal LO and the output signal of the low-noise amplifier 102 for outputting to the filter 104. The filtered signal is transmitted to the variable gain amplifier (VGA) 105 for being amplified. Then, the analog-to-digital converter (ADC) 106 converts the amplified signal for transmitting to the base-band circuit 107 for processing. However, the problem of wireless interference could be occurred when there are multiple wireless communication devices. Therefore, the technology of adaptive frequency hopping (AFH) has been developed, and the adaptive frequency hopping technology is used in the Bluetooth technology.

Please refer to FIG. 2 illustrating the searching of the interference made by the conventional wireless receiver. For Bluetooth applications, the adaptive frequency hopping technology can scan a plurality of channels to find out any good channel in order to avoid interference, for example, 20 channels of the 78 channels can be selected as the good channels. An effective channel classification is the key to success of the adaptive frequency hopping. When the environment is changed, the good channels and the bad channels may be changed. However, the more channel scanning operations are performed, the more power consumption it would need, and the more bandwidth it would be used. Besides, the interference may not happen frequently. As shown in FIG. 2, the Wifi interference is given as an example, the occurred Wifi interference time interval could be as short as 200 micro-seconds (us). Thus, when a random scanning is performed it would consume a lot of power and it may be inefficient. As shown in FIG. 2, when scanning each of the channels in 48.75 milli-seconds (ms), the frequency scanning blocks SS indicating the scanning time intervals of the channels do not encounter the existed Wifi interferences, because the interferences only exist in certain time intervals of certain channels.

### SUMMARY OF THE INVENTION

The object of the instant disclosure is to provide a wireless interference scanning method and a device for adaptive frequency hopping which apply a wide-band scanning before the interference scanning for each of the channels, in order to reduce unnecessary scanning time and power consumption.

In order to achieve the aforementioned objects, according to an embodiment of the instant disclosure, a wireless interference scanning method for adaptive frequency hopping is offered. The wireless interference scanning method comprises detecting the overall signal magnitude over a wide-band; determining whether the overall signal magnitude over the wide-band is larger than a threshold; sequentially detecting a plurality of channels in the wide-band to determine whether there is an interference signal in the channels when the overall signal magnitude over the wide-band is larger than the threshold; and redetecting the overall signal magnitude over the wide-band and determining whether the overall signal magnitude over the wide-band is larger than the threshold again when the overall signal magnitude over the wide-band is not larger than the threshold.

In order to achieve the aforementioned objects, according to an embodiment of the instant disclosure, a wireless interference scanning device for adaptive frequency hopping is offered. The wireless interference scanning device is coupled to a wireless receiver, and the wireless interference scanning device comprises a wide-band interference detecting circuit and a control circuit. The wide-band interference detecting circuit is coupled to an antenna and a base-band circuit of the wireless receiver, for receiving a wide-band signal by the antenna to generate a voltage value representing the overall signal magnitude over the wide-band. The control circuit is coupled to the wide-band interference detecting circuit and the wireless receiver. The control circuit determines whether the voltage value is larger than a threshold, and sequentially detects a plurality of channels in the wide-band to determine whether there is an interference signal in the channels when the voltage value is larger than the threshold.

In order to achieve the aforementioned objects, according to an embodiment of the instant disclosure, a wireless interference scanning device for adaptive frequency hopping is offered. The wireless interference scanning device is coupled to a wireless receiver. The wireless receiver has an antenna, a low-noise amplifier, a mixer, a filter, a variable gain amplifier and a base-band circuit. The wireless interference scanning device comprises a bypass switch and a control circuit. The bypass switch is coupled to two terminals of the filter of the wireless receiver. The control circuit is coupled to the bypass switch. The control circuit closes the bypass switch for causing a wide-band signal of a wide-band from the low-noise amplifier and the mixer be transmitted to the variable gain amplifier. The variable gain amplifier converts the wide-band signal to a voltage value, and the voltage value represents the overall signal magnitude over the wide-band. The control circuit determines whether the voltage value is larger than a threshold, and sequentially detects a plurality of channels in the wide-band to determine whether there is an interference signal in the channels when the voltage value is larger than the threshold.

In summary, the provided wireless interference scanning method and device for adaptive frequency hopping could achieve wireless interference scanning. Sequentially detection for a plurality of channels in the wide-band is performed only when the signal of interference in wide-band scanning is obtained, whereby the scanning time can be saved, and the power consumption of interference scanning can be saved too.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of a conventional wireless receiver;

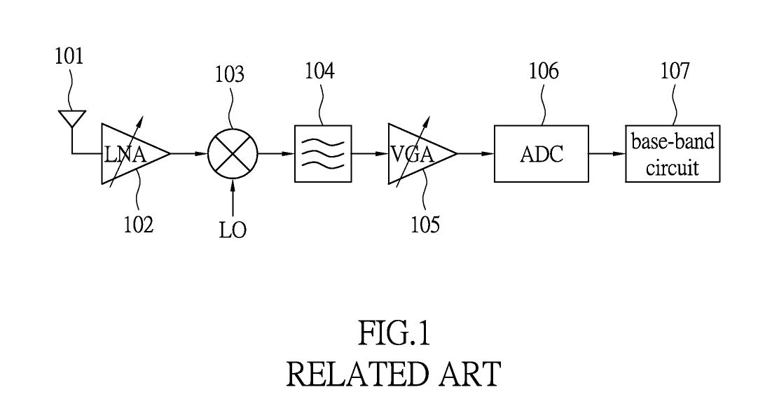

FIG. 2 illustrates the searching of the interference made by the conventional wireless receiver;

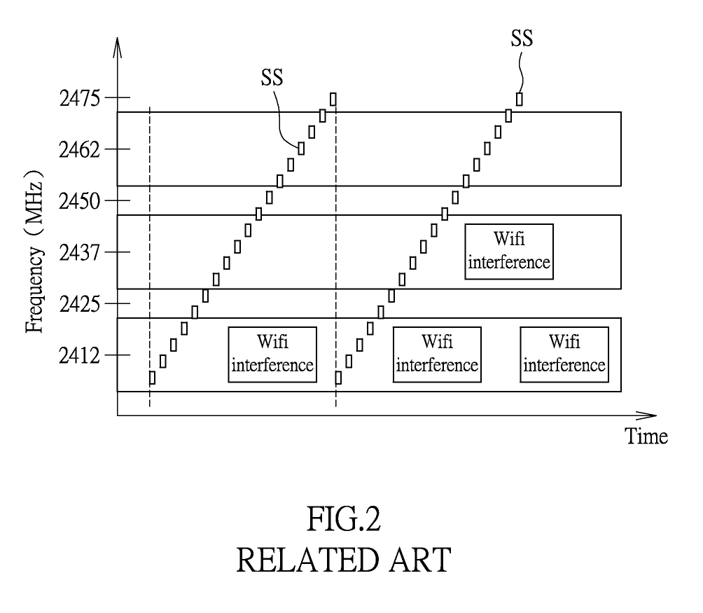

FIG. 3 shows a flow chart of a wireless interference scanning method for adaptive frequency hopping according to an embodiment of the instant disclosure;

FIG. 4 shows a schematic diagram of a wireless interference scanning device for adaptive frequency hopping according to an embodiment of the instant disclosure;

FIG. 5 illustrates the searching of the interference made by wireless interference scanning method for adaptive frequency hopping according to an embodiment of the instant disclosure; and

FIG. 6 shows a schematic diagram of a wireless interference scanning device for adaptive frequency hopping according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment of a Wireless Interference Scanning Method for Adaptive Frequency Hopping]

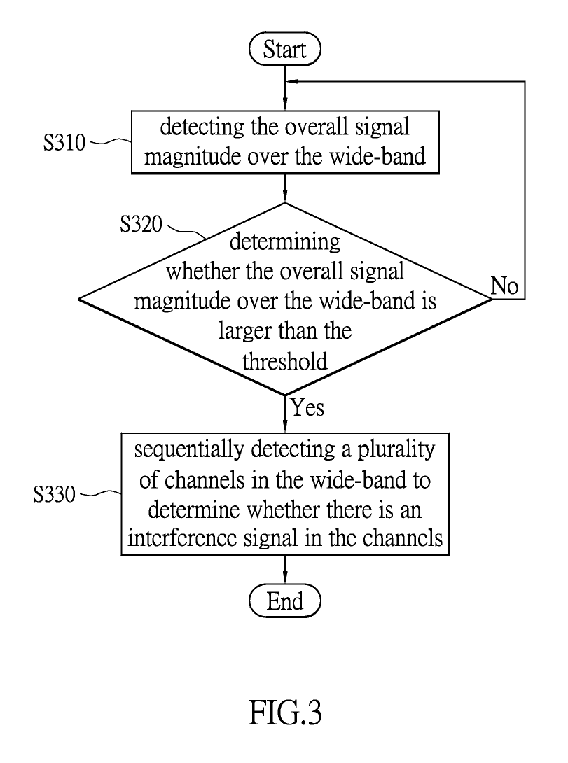

Please refer to FIG. 3 showing a flow chart of a wireless interference scanning method for adaptive frequency hopping according to an embodiment of the instant disclosure. Firstly, in step S310, detecting the overall signal magnitude over the wide-band. Then, in step S320, determining whether the overall signal magnitude over the wide-band is larger than a threshold. The mentioned wide-band may comprise the Industrial Scientific Medical Band, for example the Bluetooth device uses the band about 2.4 GHz, but the instant disclosure is not so restricted. The mentioned wide-band may also be the band about 5 GHz which is defined in the specification of 802.11a standard. When overall signal magnitude over the wide-band is larger than the threshold (−35 dBm for example), executing step S330. In step S330, sequentially detecting a plurality of channels in the wide-band to determine whether there is an interference signal in the channels.

Therefore, a wide-band scanning (which comprises step S310 and step S320) is performed before the interference scanning operation of each of the channels is executed. When the wide-band scanning obtains that the interference signal is too large (compared with the threshold), then performing the interference scanning for each channel. When the overall signal magnitude over the wide-band is not larger than the threshold, executing step S310 and step S320 again, that is redetecting the overall signal magnitude over the wide-band and determining whether the overall signal magnitude over the wide-band is larger than the threshold again. Besides, after step S330 is over, the aforementioned flow of steps could be executed again in order to perform the next interference detection.

It is worth mentioning that before step S310, which is before detecting the overall signal magnitude over the wide-band, the method further comprises a step of zero calibration, in order to reduce the error of wide-band scanning. The step of zero calibration would be described in the follow-up embodiments hereinafter.

The wireless interference scanning device performing the aforementioned wireless interference scanning method may be a conventional wireless receiver cooperated with a wide-band monitoring circuit which is in parallel connection to the input terminal (for receiving the signal of the antenna) of the conventional wireless receiver, or the wireless interference scanning method may be realized by utilizing a bypass mechanism applied to the filter of the conventional wireless receiver. Please refer to details of the subsequent embodiments.

[An Embodiment of a Wireless Interference Scanning Device for Adaptive Frequency Hopping]

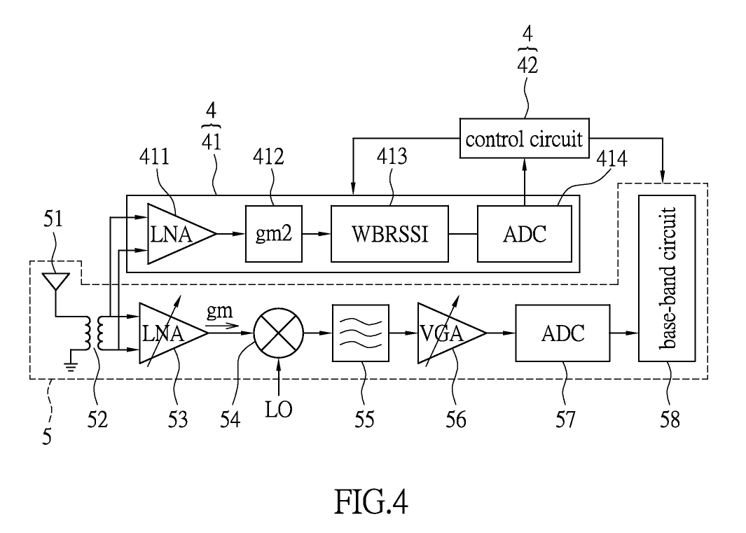

Please refer to FIG. 4 showing a schematic diagram of a wireless interference scanning device for adaptive frequency hopping according to an embodiment of the instant disclosure. The wireless interference scanning device in this embodiment is a conventional wireless receiver cooperated with a wide-band monitoring circuit in parallel connection to the input terminal (for receiving the signal of the antenna) of the conventional wireless receiver. The wireless interference scanning device 4 is coupled to a wireless receiver 5. The wireless receiver 5 comprises an antenna 51, a coupling circuit 52, a low-noise amplifier (LNA) 53, a mixer 54, a filter 55, a variable gain amplifier (VGA) 56, an analog-to-digital converter (ADC) 57 and a base-band circuit 58. In this embodiment, the wireless interference scanning device 4 comprises a wide-band interference detecting circuit 41 and a control circuit 42, for performing the detecting operation for the interference source, in order to solve the problem of too much time and unnecessary power consumption in interference scanning of the conventional adaptive frequency hopping wireless receiver mentioned in the related art.

Please refer to FIG. 3 in conjunction with FIG. 4, the wide-band interference detecting circuit 41 is coupled to the antenna 51 of the wireless receiver 5 through the coupling circuit 52 and the wide-band interference detecting circuit 41 is coupled the base-band circuit 58 of the wireless receiver 5. The wide-band interference detecting circuit 41 is for receiving a wide-band signal by the antenna 51 to generate a voltage value representing the overall signal magnitude over the wide-band, which is corresponding to step S310 of FIG. 3. The control circuit 42 is coupled to the wide-band interference detecting circuit 41 and the wireless receiver 5 for controlling the wide-band interference detecting circuit 41 and the wireless receiver 5. The control circuit 42 determines whether the voltage value is larger than the threshold, which is corresponding to step S320 of FIG. 3. The control circuit 42 controls the wireless receiver 5 to sequentially detect the plurality of channels in the wide-band to determine whether there is any interference signal in the channels when the voltage value is larger than the threshold, which is corresponding to step S330 of FIG. 3. The mentioned threshold may be −35 dBm for example, but the instant disclosure is not so restricted. In other words, the control circuit 42 controls the operation of the wide-band interference detecting circuit 41 and controls the wireless receiver 5 to proceed interference scanning for each of the channels when the overall signal magnitude over the wide-band is significantly stronger than the threshold, in order to save the scanning time and power consumption.

The wide-band interference detecting circuit 41 comprises a low-noise-amplifier (LNA) 411, a mixer 412, a wide-band received signal strength indicator (WBRSSI) 413 and an analog-to-digital converter (ADC) 414. An input terminal of the low-noise amplifier 411 is coupled to the antenna 51 of the wireless receiver 5 for receiving the wide-band signal. The mixer 412 is coupled to the low-noise amplifier 411, in order to output the amplified signal gm2. The wide-band received signal strength indicator 413 is coupled to the mixer 412. The wide-band received signal strength indicator 413 converts the wide-band signal gm2 coming from the low-noise amplifier 411 and the mixer 412 to the mentioned voltage value. The wide-band received signal strength indicator 413 includes the functions of applying a frequency down conversion to the input signal and converting the input signal to a corresponding voltage value.

The analog-to-digital converter 414 is coupled to the wide-band received signal strength indicator 413. The analog-to-digital converter 414 digitalizes the voltage value and transmits the digitalized voltage value to the base-band circuit 58 of the wireless receiver 5. The consumed current of the wide-band interference detecting circuit 41 may small as to 5 mA. In contrast, the consumed current of the wireless receiver 5 while proceeding the interference scanning for each of the channels is about 25 mA, thus it can be seen that the power consumption could effectively be saved by utilizing the wide-band interference detecting circuit 41 to perform wide-band interference scanning.

It is worth mentioning that, in general, the now-noise amplifier 411 of the wide-band interference detecting circuit 41 has a DC offset. Thus, the input of the low-noise amplifier 411 can be turned off to record the DC offset of the low-noise amplifier 411 before the wide-band scanning, whereby the zero calibration can be made.

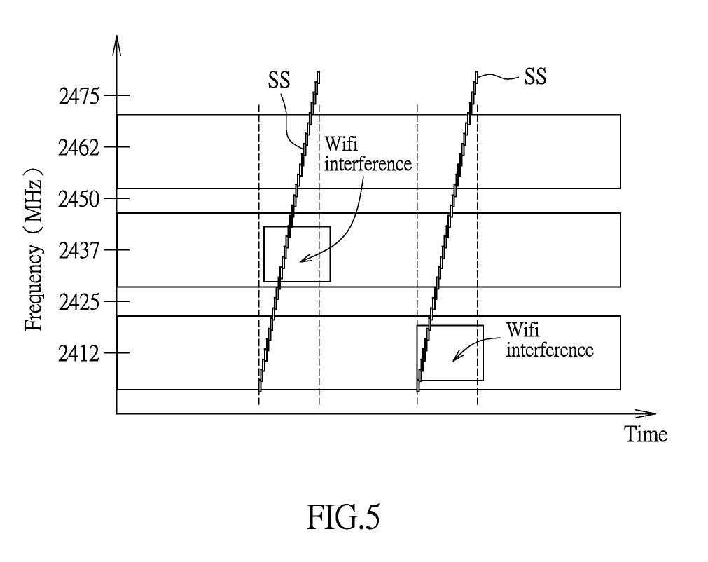

Please refer to FIG. 3 in conjunction with FIG. 5, FIG. 5 illustrates the searching of the interference made by wireless interference scanning method for adaptive frequency hopping according to an embodiment of the instant disclosure. In FIG. 5, the example of scanning Wifi interference about 2.4 GHz is adopted also, and the searching manner illustrated by FIG. 5 is corresponding to the scanning method of step S330 in FIG. 3. The step of sequentially detecting the plurality of channels in the wide-band to determine whether there is an interference signal in the channels is performed in one time-slot. The plurality of channels may be the channels of the Bluetooth wireless technology standard, in which the time length of the time-slot is 625 us. The embodiment is for saving the scanning time of step S330, thus the scanning is faster in order to find out in which channel (or channels) the interference signal(s) exists when wide-band interference is detected. Therefore, the scanning efficiency could be improved. However, the instant disclosure is not so restricted. In other embodiment, the step of sequentially detecting the plurality of channels in the wide-band to determine whether there is an interference signal in the channels may be performed in in 0.5 millisecond to 1 millisecond (which is 500 us to 1000 us).

Additionally, the frequencies of the interference signals are not so restricted, and the source of the interference signals is not restricted too. For example, the interference signals may be generated by a microwave oven. The frequencies of the interference signals from the microwave oven are located in the Industrial Scientific Medical Band (ISM-Band). Further, the interference signals from other wireless device or device may cause wireless interference could be the interference source. The frequency range of the interference scanning is determined by the applied wireless receiver.

[Another Embodiment of a Wireless Interference Scanning Method for Adaptive Frequency Hopping]

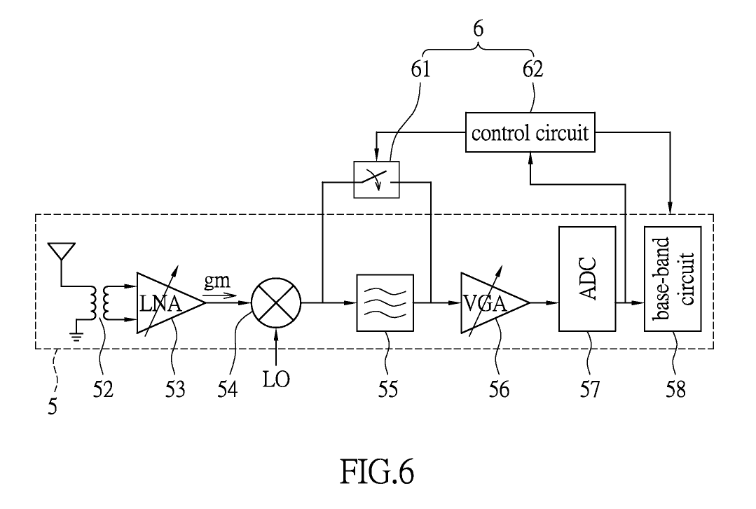

Please refer to FIG. 3 in conjunction with FIG. 6, FIG. 6 shows a schematic diagram of a wireless interference scanning device for adaptive frequency hopping according to another embodiment of the instant disclosure. This embodiment is realized by utilizing a bypass mechanism applied to the filter of the conventional wireless receiver. The wireless interference scanning device 6 is coupled to the wireless receiver 5. The wireless receiver 5 comprises the antenna 51, the coupling circuit 52, the low-noise amplifier 53, the mixer 54, the filter 55, the variable gain amplifier 56 and the base-band circuit 58. The wireless interference scanning device 6 comprises a bypass switch 61 and a control circuit 62.

The bypass switch 61 is coupled to two terminals of the filter 55 of the wireless receiver 5. The control circuit 62 is coupled to the bypass switch 61. In wide-band interference scanning, step S310, the control circuit 62 closes the bypass switch 61 for causing a wide-band signal gm of a wide-band from the low-noise amplifier 53 and the mixer 54 be transmitted to the variable gain amplifier 56. The variable gain amplifier 56 converts the wide-band signal (gm) to a voltage value, and the voltage value represents the overall signal magnitude over the wide-band.

Please refer to FIG. 3 in conjunction with FIG. 5 and FIG. 6, in other words, the signal (analog signal voltage value) amplified by the variable gain amplifier 56 which is from the low-noise amplifier 53 and the mixer 54 and not filtered is similar to the (analog) voltage value outputted by the wide-band received signal strength indicator 413 shown in FIG. 5. It can be seen that this embodiment provides another wireless interference scanning device to perform the step S310. Additionally, compared to the embodiment disclosed in FIG. 5, the embodiment disclosed in FIG. 6 utilizes the low-noise amplifier 53, the mixer 54 and the variable gain amplifier 56 of the conventional wireless receiver 5 in order to replace the low-noise-amplifier 411, the mixer 412 and the wide-band received signal strength indicator 413 of the wide-band interference detecting circuit 41, thus the architecture of the circuit could be further simplified.

The control circuit 65 determines whether the voltage value outputted by the variable gain amplifier 56 is larger than the threshold. For example, the control circuit 62 obtains the digitalized voltage value from the base-band circuit 58, or the control circuit 65 could be coupled to the output of the variable gain amplifier 56 to obtain the analog voltage value, but the instant disclosure is not so restricted. The control circuit 65 opens the bypass switch 61, and controls the wireless receiver 5 to sequentially detect the plurality of channels in the wide-band to determine whether there is any interference signal in the channels when the voltage value is larger than the threshold.

According to above descriptions, the provided wireless interference scanning method and device for adaptive frequency hopping could achieve wireless interference scanning. Sequentially detection for a plurality of channels in the wide-band is performed only when the signal of interference in wide-band scanning is obtained, whereby the scanning time can be saved, and the power consumption of interference scanning can be saved too.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A wireless interference scanning method for adaptive frequency hopping, comprising:
detecting the overall signal magnitude over a wide-band;
determining whether the overall signal magnitude over the wide-band is larger than a threshold;
sequentially detecting a plurality of channels in the wide-band to determine whether there is an interference signal in the channels when the overall signal magnitude over the wide-band is larger than the threshold; and
redetecting the overall signal magnitude over the wide-band and determining whether the overall signal magnitude over the wide-band is larger than the threshold again when the overall signal magnitude over the wide-band is not larger than the threshold.

2. The wireless interference scanning method for adaptive frequency hopping according to claim 1, wherein the wide-band comprises the Industrial Scientific Medical Band.

3. The wireless interference scanning method for adaptive frequency hopping according to claim 1, wherein the step of sequentially detecting the plurality of channels in the wide-band to determine whether there is an interference signal in the channels is performed in one time-slot.

4. The wireless interference scanning method for adaptive frequency hopping according to claim 3, wherein the plurality of channels are the channels of the Bluetooth wireless technology standard, in which the time length of the time-slot is 625 us.

5. The wireless interference scanning method for adaptive frequency hopping according to claim 1, wherein the step of sequentially detecting the plurality of channels in the wide-band to determine whether there is an interference signal in the channels is performed in 0.5 millisecond to 1 millisecond.

6. The wireless interference scanning method for adaptive frequency hopping according to claim 1, wherein before the step of detecting the overall signal magnitude over the wide-band the method further comprises a step of zero calibration.

7. A wireless interference scanning device for adaptive frequency hopping, coupled to a wireless receiver, the wireless interference scanning device for adaptive frequency hopping comprising:
a wide-band interference detecting circuit, coupled to an antenna and a base-band circuit of the wireless receiver, for receiving a wide-band signal by the antenna to generate a voltage value representing the overall signal magnitude over the wide-band; and
a control circuit, coupled to the wide-band interference detecting circuit and the wireless receiver, determining whether the voltage value is larger than a threshold, and sequentially detecting a plurality of channels in the wide-band to determine whether there is an interference signal in the channels when the voltage value is larger than the threshold.

8. The wireless interference scanning device for adaptive frequency hopping according to claim 7, wherein the wide-band interference detecting circuit comprises:
a low-noise-amplifier (LNA), an input terminal of the low-noise amplifier coupled to the antenna of the wireless receiver for receiving the wide-band signal;
a mixer, coupled to the low-noise amplifier;
a wide-band received signal strength indicator (WBRSSI), coupled to the mixer, converting the wide-band signal coming from the low-noise amplifier and the mixer to the voltage value; and
an analog-to-digital converter (ADC), coupled to the wide-band received signal strength indicator, digitalizing the voltage value, and transmitting the digitalized voltage value to the base-band circuit of the wireless receiver.

9. The wireless interference scanning device for adaptive frequency hopping according to claim 7, wherein the operation of sequentially detecting the plurality of channels in the wide-band to determine whether there is an interference signal in the channels is performed in 0.5 millisecond to 1 millisecond

10. A wireless interference scanning device for adaptive frequency hopping, coupled to a wireless receiver, the wireless receiver having an antenna, a low-noise amplifier, a mixer, a filter, a variable gain amplifier and a base-band circuit, the wireless interference scanning device for adaptive frequency hopping comprising:
a bypass switch, coupled to two terminals of the filter of the wireless receiver; and
a control circuit, coupled to the bypass switch, the control circuit closing the bypass switch for causing a wide-band signal of a wide-band from the low-noise amplifier and the mixer be transmitted to the variable gain amplifier, the variable gain amplifier converting the wide-band signal to a voltage value, the voltage value representing the overall signal magnitude over the wide-band, the control circuit determining whether the voltage value is larger than a threshold, and sequentially detecting a plurality of channels in the wide-band to determine whether there is an interference signal in the channels when the voltage value is larger than the threshold.
